(19) United States
(12) Patent Application Publication
(10) Pub. No.: US 2004/0168119 A1
(43) Pub. Date: Aug. 26, 2004

(54) method and apparatus for creating a report

(76) Inventors: David Liu, Granada Hills, CA (US); Gerald Dennis Berman, Santa Monica, CA (US); Richard Neal Gray, Los Angeles, CA (US)

Correspondence Address: SIDLEY AUSTIN BROWN & WOOD LLP, 717 NORTH HARWOOD, SUITE 3400, DALLAS, TX, 75201, US

(21) Appl. No.: 10/374,409

(22) Filed: Feb. 24, 2003

(51) Int. Cl. G06F 15/00

(52) U.S. Cl. 715/501.1

(57) ABSTRACT

The present invention discloses a method, apparatus, and article of manufacture for creating a report on a computer. In accordance with an embodiment of the present invention, one or more nodes of a decision tree are displayed to a user. Information about the displayed nodes are then received from a user. The information includes at least one selected node. The structured report is converted into a report based on the selected nodes. In another embodiment of the present invention, the structured report is stored in a database that is connected to the computer. In a further embodiment, the structured report is electronically distributed via the Internet. The invention has utility for dynamically creating a structured report that can be accessed instantaneously.

### FIELD OF THE INVENTION

The present invention generally relates to document generation, and in particular to creating a structured report and creating an expanded report from that structured report.

### BACKGROUND OF THE INVENTION

In many industries, particularly in the healthcare industry, technicians or specialists evaluate data and generate written reports to be utilized by others in providing a service or product. Other individuals refer to the written reports to provide the appropriate service or product to the consumer. The process of creating the written reports, however, is a time-consuming and expensive process.

For example, radiologists diagnose diseases by analyzing radiological images and generate written reports describing their findings. Generally, the radiologists dictate their findings via a Dictaphone. The tapes are picked up by transcriptionists and taken off-site for transcription. Approximately 24-48 hours later, the transcribed reports are returned to the radiologist for corrections. The marked reports are picked up by the transcriptionists and taken off-site for correction. The radiologists and the transcriptionists continue in this manner until all corrections have been incorporated into the transcribed report. Finally, the radiologist signs the corrected reports, and the corrected reports are made available for distribution via runners, who typically hand-carry the corrected reports to the requesting physicians.

Technologies such as the fax and e-mail have eliminated the step of physically picking up the reports, thus, decreasing the amount of time required to produce the corrected reports. These technologies, however, failed to significantly impact the dictation and transcription time cycle.

Tele-transcription systems reduce the dictation and transcription time because the systems allow radiologists to pick up an ordinary phone and dial into a dictation system provider and report their cases. These systems eliminate the runners and cut transcription turnaround time significantly, to about 12-24 hours. Corrections to the reports, however, are still time-consuming.

Some systems utilize voice recognition technology in an attempt to reduce the dictation/transcription time. These voice recognition systems, however, have to be trained to each speaker's specific voice recognition patterns, and the accuracy rates are too low for many applications, including radiology in which an accuracy rate of 95% is not acceptable. Corrections in many of these systems are even more cumbersome, and the systems are expensive. Although the voice recognition system provides many advantages, such as the electronic distribution of reports, the disadvantages discussed above limit its usefulness.

Other systems utilize menu-based systems that provide a template for a report that contains a number of fields. Each field is filled in by the radiologist. Some fields provide a cascading set of menus that enable the radiologist to create a structured set of sentences. In these fields, the sentence is derived from the radiologist's selections in the menus. After each selection, the output sentence is updated and the radiologist continues to make selections until the output accurately states the radiologist's findings. This approach, however, has a number of shortcomings. First, each report field has its own input tree and selections in that tree create output in a single report field. This forces the reporting radiologist to create the report in the precise order in which the data appears in the output fields. Second, once a menu item has been selected, it is used to construct a sentence in the corresponding field of the report. Generally, the same menu item is not allowed to be utilized to construct multiple sentences. Third, when a particular subtree is used in many locations, it must be copied into each location of the template. Therefore, when it requires changes later, each copy must be updated. Fourth, text output is not context sensitive, which makes it difficult to generate a natural sounding report for certain phrases, such as when numerical adjectives correspond in number with the head noun in a noun phrase. Fifth, the output ordering is determined solely by the input tree structure. The order in which items from a single menu are selected does not have any affect on the output ordering.

Furthermore, the systems described generally do not provide the reports in an electronic form that enables a user to search across reports and create reports based on the content of a plurality of previously completed reports. Rather, the systems generally only provide the ability to search for specific strings of text contained within a report.

Therefore, the present invention advances the art by providing an improved technique that allows users to generate written reports.

### SUMMARY OF THE INVENTION

To overcome the limitations in the prior art described above and to overcome other limitations that will become apparent upon reading and understanding the present specification, the specification discloses a method, apparatus, and article of manufacture for creating a structured report on a computer.

In accordance with an embodiment of the present invention, one or more nodes of a decision tree are displayed to a user. Information about the displayed nodes are then received from a user. The information includes at least one selected node. The set of selected nodes constitutes a structured report, because the nodes are arranged hierarchically and there is an explicit structure imposed on the data entered by the radiologist. The text report is then dynamically created by converting the selected nodes into one or more sentences.

In another embodiment of the present invention, the structured report is stored in a database or file that is connected to the computer.

In another embodiment, the structured report is electronically distributed via the Internet.

The invention has utility for dynamically creating a structured report that can be instantaneously accessed.

### BRIEF DESCRIPTION OF THE DRAWINGS

Referring now to the drawings in which like reference numbers represent corresponding parts throughout:

FIG. 1 is a diagram of a network environment that embodies features of the present invention;

FIG. 2 is a flow chart illustrating the relationship between components of an embodiment of the present invention, including the way in which data is passed between components;

FIGS. 3a and 3b illustrate a structured report in accordance with an embodiment of the present invention;

FIG. 4 is a flow chart illustrating the process of creating an expanded report from a structured report in accordance with an embodiment of the present invention;

FIG. 5 is a flow chart illustrating one embodiment of the present invention in which nodes of a decision tree are sequenced in accordance with the properties of the nodes;

FIGS. 6a-6b illustrates one embodiment of the present invention in which a contained set is utilized to determine the sequence of nodes in an expanded report;

FIG. 7 is a flow chart illustrating one embodiment of the present invention in which a decision tree is converted into a structured report; and

FIG. 8 illustrates one embodiment of the present invention in which a findings decision tree is displayed and an expanded report is dynamically displayed.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, details concerning programming, communications, and database structures, and the like have been omitted inasmuch as such details are not considered necessary to obtain a complete understanding of the present invention, and are considered to be within the skills of persons of ordinary skill in the relevant art.

It is further noted that, unless otherwise indicated, all functions described herein may be performed by either hardware or software, or some combination thereof. In a preferred embodiment, however, the functions are performed by a processor such as a computer or an electronic data processor in accordance with code such as computer program code, software, and/or integrated circuits that are coded to perform such functions, unless otherwise indicated.

The present invention provides a method and an apparatus for generating a structured report and, from that structured report, generating an expanded report. As one of ordinary skill in the art will appreciate, the present invention applies to any area in which a report is to be generated for use by other individuals or groups. For example, an embodiment of the present invention may be utilized in radiological, toxicological, pharmaceutical, other healthcare specialties, automotive, electronics, construction industries, or the like. For illustrative purposes only, however, the following description provides examples specific to radiology and reports generated by radiologists. A person of ordinary skill in the art, however, will appreciate that the examples are equally applicable in any industry.

As will be discussed in greater detail below, an embodiment of the invention preferably allows a user to develop report templates that define possible observations that a person may observe. After the report template is created, another user, such as a technician or specialist, observes an event and selects the appropriate observations in the report templates, creating a structured report. Grammar rules are applied to the structured report to create an expanded report. Preferably, the structured report and/or the expanded report may be electronically transmitted to other individuals or groups that require the structured or expanded reports to provide a service or product.

For example, an embodiment of the present invention provides a method and an apparatus that allow radiologists to develop report templates that define possible observations that a radiologist may observe for a particular type of radiological study, such as a chest x-ray or a CT scan of the brain. Furthermore, an embodiment of the invention preferably allows radiologists to utilize the report templates to record observations and diagnoses for a particular study, such as a chest x-ray for patient #1234 on Jul. 15, 2002, at 9:34 A.M. These observations and diagnoses are captured in a structured report. Optionally, the structured report may be converted to an expanded report by applying grammar rules. Preferably, the expanded report contains information in an easy to read format necessary for a referring physician to determine the results of the radiological study and treat the patient accordingly.

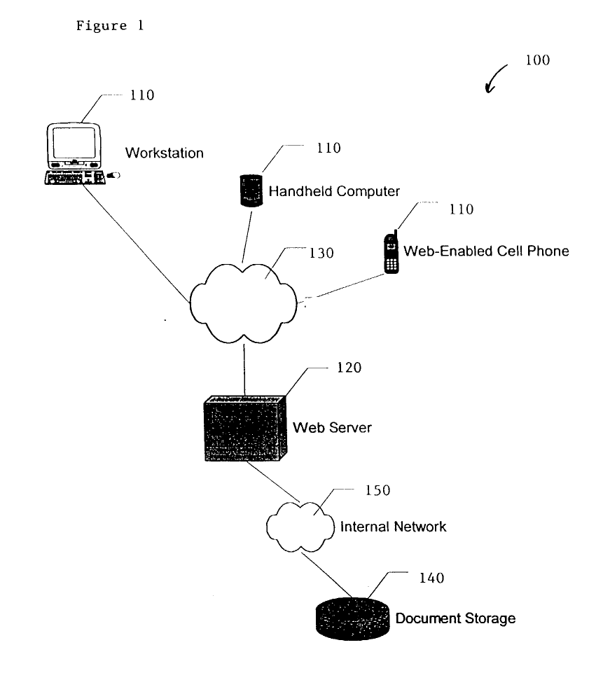

Referring to FIG. 1 of the drawings, the reference numeral 100 generally designates a portion of a reporting system, which embodies features of the present invention. Generally, the reporting system 100 comprises one or more interface devices 110, such as appliances, personal digital assistants (PDAs), wrist watches, television systems, mainframe computers, minicomputers, personal computers, workstations, handheld computers, cell phones, or the like. The interface device 110 preferably includes a processor, one or more data communications devices (e.g., modems, network interfaces, etc.), a monitor (e.g., CRT, LCD display, etc.), and an input device (e.g., a mouse and/or a keyboard). It is envisioned that attached to the client computer may be other devices such as random-access memory (RAM), read-only memory (ROM), a video card, bus interface, printers, and the like. The interface device 110 is configured to allow a user (not shown) to enter data regarding observations that the user made regarding a subject (not shown).

Optionally, the interface device 110 is coupled to a server 120 via a network 130 to enable sharing of templates, generated data and reports. Accordingly, the server 120 is preferably a server accessible via an external network, such as the Internet, to which the interface device 110 accesses via a communications link, such as a TCP/IP communications link, wireless communications link, or the like. The interface device 110 preferably accesses the server 120 through a standard web browser, such as Microsoft Corporation's Internet Explorer, utilizing standard communications protocols and document standards, such as hyper-text mark-up language (HTML), extended mark-up language (XML), or the like. Other configurations, such as local area networks (LANs), wide area networks (WANs), public networks, private networks, and the like, may be utilized depending upon the application and the desired accessibility. Other components, such as a document storage 140 are preferably accessible via an internal network 150. For security purposes, server components other than the web server 120, such as the document storage 140, are typically placed on an internal network 150 behind an internal firewall (not shown).

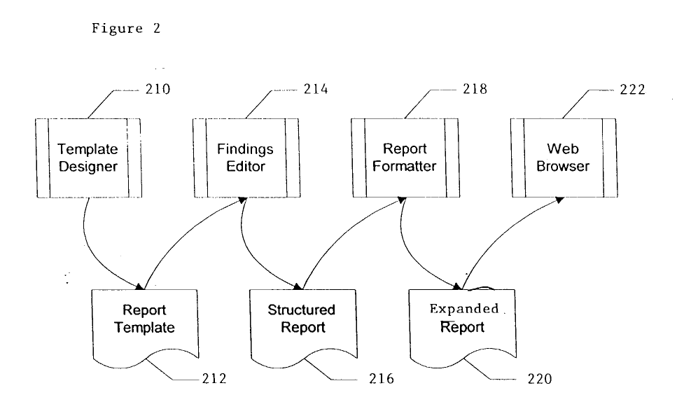

FIG. 2 illustrates the process of generating a structured report and an expanded report in accordance with one embodiment of the present invention. The processes and the data may be implemented on the interface device 110, the web server 120, the document storage 140, or some combination thereof. One of ordinary skill in the art will appreciate that an embodiment of the present invention may be implemented either in a stand-alone environment or a distributed environment.

Accordingly, a Template Designer 210 preferably provides a user interface for a designer to create a Report Template 212, i.e., a definition of possible observations that may be made regarding a particular study of a subject. Preferably, the Report Template 212 is presented by the Template Designer 210 as a hierarchical collection of nodes referred to as a decision tree, wherein each node of the Report Template 212 represents a group/classification of related items or specific alternatives regarding observations of the subject of the report. Accordingly, the hierarchical tree structure of the Report Template 212 comprises parent nodes and child nodes. Parent nodes are nodes that contain other nodes, and child nodes are nodes that have one or more parent nodes. Generally, nodes may be both a parent node and a child node. Furthermore, nodes of the Report Template 212 are preferably expandable and collapsible to provide an easy-to-use interface.

Additionally, the Template Designer 12 preferably provides editing functions, such as Add Node, Delete Node, Copy Node, Paste Node, and the like, with which the user creates a tree structure and specifies the contents of the Report Template 212. The Template Designer 210 displays a property sheet for setting the values for one or more properties of a node. Generally, a property sheet provides a mechanism that enables the user to specify the display and selection behavior properties of a node. The preferred Property Name, Data Type, and Description of the properties of each node of an embodiment of the present invention are described below in Tables 1-5, wherein Table 1 contains General Properties, Table 2 contains Relationship Properties, Table 3 contains Input Behavior Properties, Table 4 contains Output Behavior Properties, and Table 5 contains Traversal Properties. As one of ordinary skill in the art will appreciate, however, the preferred properties and their usage may differ depending upon, among other things, the intended use, the intended audience, the industry, level of expertise, and the like.

The following Tables 1-5 illustrate the preferred Property, Data Type, and Description associated with the nodes discussed above. One of ordinary skill in the art will realize that different node properties may be required dependent upon the implementation and the intended application. For example, differing data types, values, additional properties, fewer properties, or the like may be required in different implementations.

TABLE 1
General Properties

| | Data | |
|---|---|---|
| Property | Type | Description |
| Display | String | The name of the node to be displayed in the |
| Name | | Findings Editor. Default is “NewNode”. |
| UID | String | The unique identifier for this node. |
| Creation | Date | The date and time when the node was created. |
| Date/Time | | |
| Modified | Date | The date and time when the node was last modified. |
| Date/Time | | |
| Effective | Date | The beginning date and time when the node may be |
| Date/Time | | used. Prior to this date, the Findings Editor should |
| | | not display this node. Default is the creation date. |
| Expiration | Date | The last date and time when the node may be used. |
| Date/Time | | After this date, the Findings Editor should not |
| | | display this node. If no date is specified, the node |
| | | will never expire. Default is no date. |
| Derived | String | The unique identifier of the node from which this |
| from | | node was derived. A node may be derived from |
| template | | another node at design time, either by copying or by |
| UID | | creating an alias. Default is the empty string. |
| URL | String | A universal resource locator that specifies additional |
| | | reference information related to this node that may |
| | | be displayed in the Findings Editor. Default is the |
| | | empty string. |
| Tip | String | A short string that may be displayed in the Findings |
| | | Editor to help the user understand the purpose of |
| | | this node. This is “help” text that is displayed |
| | | when the cursor hovers over the node. Default is |
| | | the empty string. |

TABLE 2
Relationship Properties

| Property | Data Type | Description |
|---|---|---|
| Parent | Node | The UID of this node's parent node. If this is the root |
| | | node, the Parent will display as the empty string. |
| Children | List of Node | The labels of this node's children, if any. |
| Only one child | Boolean | If ‘true’, the Findings Editor will allow the user to |
| selected | | select no more than one of this node's children. This |
| | | property is mutually exclusive with ‘All children |
| | | selected’. Default is ‘false’, in which case the user will |
| | | be allowed to select more than one child. |
| At least one child | Boolean | If ‘true’, the Findings Editor will require the user to |
| selected | | select at least one of this node's children. Default is |
| | | ‘false’. |
| Children's order | Boolean | If ‘true’, the Value derived from this node's children is |
| fixed | | determined by the order in which they appear in the |
| | | decision tree. Otherwise, their values are aggregated |
| | | in the order in which they are selected in the Findings |
| | | Editor. Default is ‘true’. |
| Delimiter | Enumeration | {Space, Comma, And}. Specifies the way in which |
| | | children's values are to be combined. This delimiter is |
| | | inserted between the values of the children. ‘Comma’ |
| | | indicates that the child values are separated by a |
| | | comma; ‘And’ indicates that the conjunction “and” is |
| | | inserted before the last of a series of child values. |
| | | Default value is ‘Space’, in which case child values are |
| | | separated by a space. |
| Co-existence | List of Node | If this node is selected in the Findings Editor, then the |
| Nodes | | co-existence nodes must also be selected. |
| Exclusion Nodes | List of Node | If this node is selected in the Findings Editor, then the |
| | | exclusion nodes may not be selected. |
| Alias Template | String | Reference to another template whose root node is to |
| | | inserted into the current template at this location in |
| | | the tree. |

TABLE 3
Input Behavior Properties

| Property | Data Type | Description |
|---|---|---|
| Data Source | Enumeration | {Prompt the user, Get from node, Get from database}. |
| | | Specifies the source of data to be placed into the Value |
| | | property at runtime in the Findings Editor. ‘Prompt |
| | | the user’ indicates that the user supplies the value. |
| | | ‘Get from node’ references the value of another node. |
| | | ‘Get from database’ gets the value from a database. |
| | | Default is ‘Prompt the user’. |
| Prompt | String | The string to be displayed by the Findings Editor as a |
| | | prompt to request the user to enter a value. |
| Parameter Name | String | The name of the parameter to be displayed in the |
| | | design tool. Default is the empty string. |
| Label | String | The name of the parameter to be displayed in the |
| | | Findings Editor. Default is the empty string. |
| Data Type | Enumeration | {String, Date, Number}. The type of data to be |
| | | entered by the user. The Findings Editor should |
| | | validate user input against this type. Default is |
| | | ‘String’. |
| Format | String | The string may refer to a parameter, e.g. “${size in |
| | | cm} cm”, where “size in cm” is the value entered by |
| | | the user, but something like “4 cm” will be the value of |
| | | this node. Default is the empty string. |
| Required | Boolean | If ‘true’, the user must enter a non-null value in the |
| | | Findings Editor. |
| Maximum | String | The maximum value that may be assigned to this |
| | | parameter. If the user tries to enter a value that is |
| | | greater than this value, the Findings Editor will not |
| | | accept the value. Default is the empty string. |
| Minimum | String | The minimum value that may be assigned to this |
| | | parameter. If the user tries to enter a value that is less |
| | | than this value, the Findings Editor will not accept the |
| | | value. Default is the empty string. |
| Usual Maximum | String | The maximum value that may be assigned to this |
| | | parameter. If the user tries to enter a value that is |
| | | greater than this value, the Findings Editor will warn |
| | | the user. However, if the user confirms the value, then |
| | | it will be accepted. Default is the empty string. |
| Usual Minimum | String | The minimum value that may be assigned to this |
| | | parameter. If the user tries to enter a value that is less |
| | | than this value, the Findings Editor will warn the user. |
| | | However, if the user confirms the value, then it will be |
| | | accepted. Default is the empty string. |
| Default Value | String | The default value to be supplied by the Findings |
| | | Editor when prompting the user for a value. Default is |
| | | the empty string. |
| Value | String | The value entered by the user through the Findings |
| | | Editor. Default is the empty string. |
| Pre-functoids | String | The name of a pre-functoid, which is a function that is |
| | | performed before the user enters a value in the |
| | | Findings Editor. |
| Post-functoids | String | The name of a post-functoid, which is a function that |
| | | is performed after the user enters a value in the |
| | | Findings Editor. |

TABLE 4
Output Behavior Properties

| Property | Data Type | Description |
|---|---|---|
| Is Required | Boolean | If ‘true’, the report tool will require the user to enter a |
| | | value. Default is ‘false’. |
| Selection | Integer | The relative order in which this node was selected with |
| sequence | | respect to its siblings. This number is needed in the |
| | | case where child values are listed in the order in which |
| | | the children were selected in the Findings Editor. |
| Value | String | The value to be displayed for this node in the report. |
| Is Sentence | Boolean | If ‘true’, the Value of this node is to be treated as a full |
| | | sentence in the report. Otherwise, the Value will be |
| | | treated as a phrase that modifies its parent. Default is |
| | | ‘false’. |
| Is Paragraph | Boolean | If ‘true’, insert a paragraph boundary before printing |
| | | the value of this node. Default is ‘false’. |
| Triggers number | Enumeration | {None, Singular, Plural}. If ‘Singular’, the singular |
| agreement | | Value will be used from siblings. If ‘Plural’, the Plural |
| | | Object Value will be used from siblings. If ‘None’, this |
| | | node has no influence on the choice of values from |
| | | sibling nodes. Default value is ‘None’. |
| Plural value | String | If the Object Value is a noun, then the plural form of |
| | | the word should be specified. For example, |
| | | “mass”/“masses”, “tibia”/“tibiae”, “congestive heart |
| | | failure”/“congestive heart failures”. |
| Object placement | Enumeration | {Prepend to parent's object, Replace parent's object, |
| | | Append to parent's object}. Default value is ‘Append |
| | | to parent's object’. |
| Pre-functoids | String | The name of a pre-functoid, which is a function that is |
| | | performed before the user enters a value in the |
| | | Findings Editor. |
| Post-functoids | String | The name of a post-functoid, which is a function that |
| | | is performed after the user enters a value in the |
| | | Findings Editor. |

TABLE 5
Traversal Behavior Properties

| Property | Data Type | Description |
|---|---|---|
| Is Selected | Boolean | If ‘true’, the node has been selected either explicitly by |
| | | the user or implicitly by inclusion (see the Co- |
| | | Existence Nodes property in the Relationship |
| | | properties). Otherwise, the node has not been |
| | | selected, so it should not appear in the findings report. |
| Is Repeatable | Boolean | If ‘true’, the node may be selected more than once in |
| | | the Findings Editor, in order to generate a sequence of |
| | | values. Otherwise, the node may only be selected once |
| | | to generate a single value. For repeating nodes, only |
| | | the Value is included in subsequent occurrences of the |
| | | node. The Prefix Value and Suffix Value are not |
| | | repeated for each occurrence of the repeating node. |
| | | Only the Prefix Value from the first occurrence is used |
| | | and only the Suffix Value from the last occurrence. |
| | | Default is ‘false’. |
| Number of times | Integer | The maximum number of times that a node may be |
| | | repeated in the Findings Editor. Default is o. |
| Repeat Traversal | Integer | A sequence counter that indicates which instance this |
| Count | | note is in a sequence of repetitions. |
| Get from Node | Node | This node gets the number of times to repeat from a |
| | | number value specified in the given node. |
| Children Before | Enumeration | {None, Auto expand, Auto collapse}. Specifies the |
| Traversal | | display of child nodes in the Findings Editor before |
| | | this node has been selected. ‘Auto expand’ causes the |
| | | child nodes to be displayed even before this node is |
| | | selected. ‘Auto collapse’ causes the child nodes to not |
| | | be displayed until the user explicitly selects this node. |
| | | Default is ‘None’. |
| Children During | Enumeration | {None, Auto expand, Auto collapse}. Specifies the |
| Traversal | | display of child nodes in the Findings Editor when this |
| | | node is selected. ‘Auto expand’ causes the child nodes |
| | | to be displayed when this node is selected. ‘Auto |
| | | collapse’ causes the child nodes to not be displayed |
| | | even when the user explicitly selects this node. |
| | | Default is ‘Auto expand’. |
| Children After | Enumeration | {None, Auto expand, Auto collapse}. Specifies the |
| Traversal | | display of child nodes in the Findings Editor when |
| | | some other node is selected that is not a descendent of |
| | | this node. ‘Auto expand’ causes the child nodes to |
| | | remain displayed when the other node is selected. |
| | | ‘Auto collapse’ causes the child nodes to not be |
| | | displayed when the user explicitly selects outside of |
| | | this node's descendents. Default is ‘None’. |
| Hide Node | Boolean | If ‘true’, this node is not displayed by the Findings |
| | | Editor. This node's value will still appear in the |
| | | output, although the node itself will not be rendered |
| | | through the Findings Editor. Default is ‘false’. |
| Hide Children | Boolean | If ‘true’, this node's children will not be displayed by |
| | | the Findings Editor. The children nodes' values will |
| | | still appear in the output, although the nodes |
| | | themselves will not be rendered through the Findings |
| | | Editor. Default is ‘false’. |
| Hide all | Boolean | If ‘true’, none of this node's descendents will be |
| descendants | | displayed by the Findings Editor. The descendent |
| | | nodes' values will still appear in the output, although |
| | | the nodes themselves will not be rendered through the |
| | | Findings Editor. Default is ‘false’. |
| Expansion Style | Enumeration | {Tree, System, None, CSS, Horizontal Radio Group, |
| | | Vertical Radio Group, Horizontal Checkbox Group, |
| | | Vertical Checkbox Group, Pull-down List, List, Table, |
| | | Input Box, Text Box}. Specifies the type of control |
| | | used by the Findings Editor to display this node's |
| | | children. Default is ‘Tree’. |
| Selectable by user | Boolean | If ‘true’, then the user can ‘select’ the node at runtime. |
| | | Otherwise, the user cannot manually ‘select’ the node. |
| | | However, regardless of the value, the system itself can |
| | | ‘select’ this node, e.g. via co-existence or selection by |
| | | inference. |

Additionally, the Template Designer 210 may embody procedure codes and diagnostic codes in the Report Template 212. Taxonomies embody knowledge on procedures, clinical information, techniques, limitations and comparisons. As users navigate these taxonomies and make selections to describe the actions that were performed during a procedure, their selections in the template triggers the system to automatically generate the corresponding procedure codes (CPT codes) and diagnostic codes (ICD codes) for the report.

This approach for automatically generating procedure codes and diagnostic codes via the embodiment of knowledge on procedures, clinical information, techniques, limitations, and comparisons is applicable to many applications. For example, procedure codes and diagnostic codes are applicable in most fields of medicine, such as radiology, cardiology, pathology, surgery, and the like.

As indicated in the node attributes for Relationship Properties in Table 2, a node may contain a reference to another template. This enables a report template to contain another, so that a single source template may be used multiple times by other templates. Utilizing this technique, the Template Designer 210 provides a way for the user to insert an “alias reference” wherever a node may be placed. The alias reference is a reference to another template. The Template Designer 210 and the Findings Editor 214 (discussed below) interpret that reference, load the referenced template, and treat the alias as though it were a sub-tree of nodes that had been defined directly in the current template. A source Report Template 212 may be referenced any number of times by another template and it may be referenced any number of times by any number of templates.

Preferably, the Report Template 212 is represented as a hierarchical model of decision tree nodes that may be selected by the application user. Preferably, the user selects one or more nodes of the decision tree via a mouse click, keyboard event, voice command, or the like. The preferred embodiment is to represent Report Template 212 as an XML document. However, there are other embodiments that do not depart from the scope of the present invention. Such alternative embodiments of the Report Template may include, but are not limited to, marked-up text as in an XML document, objects in an object-oriented database, objects serialized into a binary stream and saved in a file or database, rows and columns of data in a relational database, classes for node data and behavior implemented in an object-oriented programming language, data structures and functions for node data and tree operations in a procedural programming language, a standalone component for representing and managing a tree, such as an XML parser that adheres to the Document Object Model (DOM) Application Programming Interface (API), or the like. Furthermore, the Report Template 212 is preferably displayed graphically as nodes of a hierarchical decision tree. Other embodiments, such as a static hierarchical tree display, cascading menus, columns of data where each column represents the nodes at a particular level of the hierarchy, an interactive hierarchical tree display that the user may expand or collapse nodes, a list of items, or the like, may also be utilized.

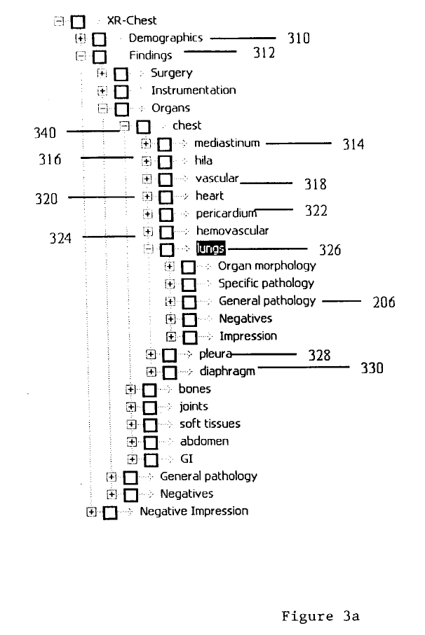

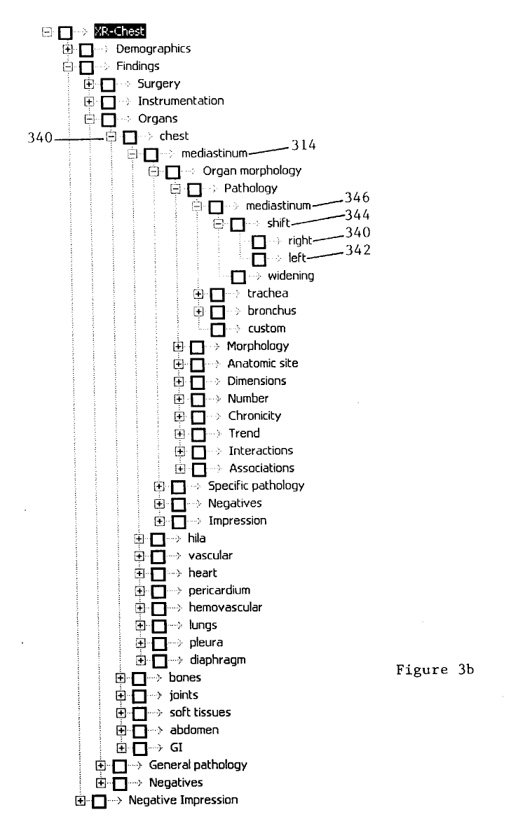

For illustrative purposes only, FIGS. 3a and 3b illustrate portions of a Report Template 212 that may be created by the Template Designer 210 for use in radiological studies in accordance with an embodiment of the present invention. A “+,” such as that displayed adjacent to group 310 labeled “Demographics,” indicates that the node is collapsed, and a “−,” such as that displayed adjacent to group 312 labeled “Findings,” indicates that the corresponding node is fully expanded, showing all child nodes of the parent node. This collapsing and expanding of nodes preferably may occur at any level and is a common mechanism employed by programs such as Microsoft Corporation's Windows Explorer program.

Groupings, such as groups 314-330, provide the template designer a mechanism to create a hierarchical structure, allowing a user, i.e., one who is generating a report, to readily locate the appropriate area of concern. FIG. 3b illustrates one of the hierarchical structures for the group 340 labeled “chest.” As one of ordinary skill in the art will appreciate, the user is able to create a template with varying groups and identifications, down to the lowest level, such as the groups 340 and 342 labeled “right” and “left,” respectively, as the lowest members of the group 344 labeled “shift,” which is a member of the group 346 labeled “mediastinum.” This process is repeated to define the relevant alternatives for the various groupings defined by the user.

A selection box, such as selection box 340, provides a mechanism to allow the user to indicate the observations relevant to a study of a subject. The purpose and function of the selection box is discussed in greater detail below with reference FIG. 2 and the Findings Editor 214.

Referring back to FIG. 2, a Findings Editor 214 preferably displays the nodes of the decision tree in the form of multiple layers similar to that illustrated in FIGS. 3a and 3b, allowing the user to select and unselect nodes. Selected nodes represent the findings, observations, or selections made by a user regarding a subject. In particular, each node represents one piece of data, such as the type of pathology observed or the size of a lesion. Preferably, if a node is selected by a user, then the “Is Selected” property of Table 1 is set to true. Preferably, the “Is Selected” property of Table 1 may also be set to true implicitly by inclusion of a related node. For example, the “Co-existence Nodes” property of Table 2 provides a user the ability when creating a Report Template 212 to specify other nodes that are automatically included upon the selection of the specified node.

Preferably, the Findings Editor 214 provides the user an option of entering data regarding the selected nodes that represent specific findings or observations regarding the subject, storing the value entered by the user in the “Value” property of Table 2. As one skilled in the art will appreciate, the “Selected” and the “Value” properties are modified by the user. The remaining properties indicate how the nodes behave and interact. As discussed above, however, other values may be added dependent upon the type of application and the specific needs of the users.

Alternatively, the user may copy a previously completed structured report and modify that structured report to accurately reflect the specific findings or observations made with respect to the current study. In this manner, the user can further reduce the amount of time required to complete the report.

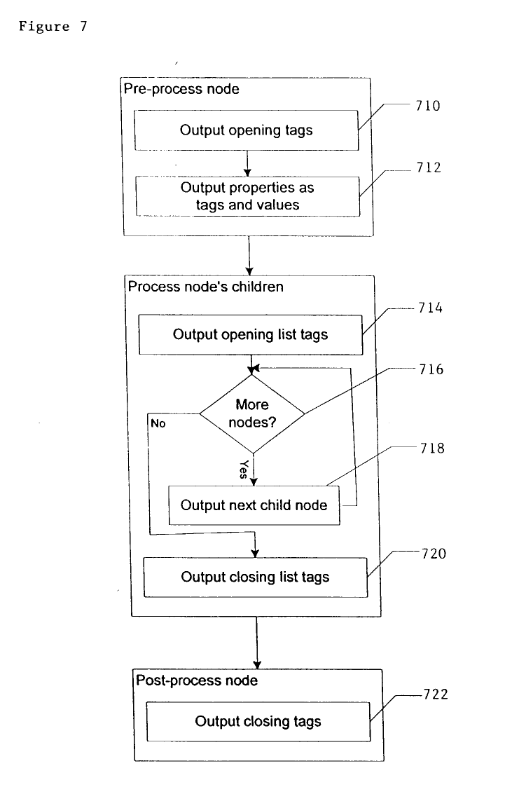

The Findings Editor 214 is described in greater detail below with reference to FIG. 7.

Based upon the nodes selected by the user, the Findings Editor 214 creates a Structured Report 216, which preferably is represented as a hierarchical model of decision tree nodes that have been selected by the application user and implemented as an XML document. Other implementations or embodiments, such as marked-up text in an XML document, objects in an object-oriented database, objects serialized into a binary stream and saved in a file or database, rows and columns of data in a relational database, or the like, do not depart from the scope of the present invention. Alternatively, the Structured Report 216 may be stored in one or more multiple formats, such as an HTML document, a text file, a PDF file, or the like.

Generally, only selected nodes will appear in a Structured Report 216. However, in some instances it will be desirable to affirmatively state that a condition or observation was not present, in which case unselected nodes may appear in a Structured Report 216.

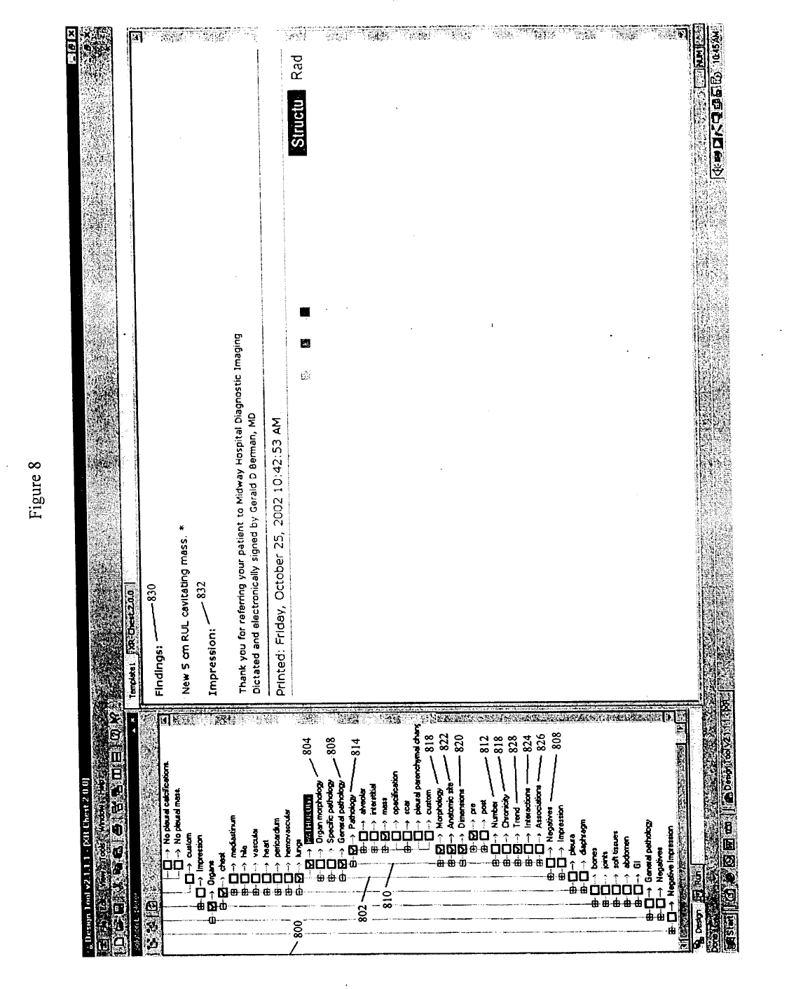

Preferably, a Report Formatter 218 (FIG. 2) utilizes the Structured Report 216, which contains the specific findings or observations made by a user, to create an Expanded Report 220. In the preferred embodiment, the Expanded Report 220 is dynamically created and displayed to the user as the user selects and deselects nodes in the decision tree. The dynamic creation and display of the Expanded Report 220 is discussed in greater detail below with reference to FIG. 8.

The Expanded Report 220 preferably presents the findings or observations made by a user in a concise, easy-to-read format in accordance with the structural position of the node with the Structured Report 216 and grammatical rules contained in the property values of the nodes and/or container set rules. A container set is a rule that specifies the sequencing of the word values associated with the nodes in the Expanded Report 220. Preferably, the container sets are implemented as either code (such as C# statements, XSL statements, or the like) or data (such as an XML document or the like).

Alternatively, the Report Formatter 218 creates the Expanded Report 220 directly from the nodes selected by the user without first creating the Structured Report 218. The Structured Report 216, however, is preferred because it allows the findings of the user to be efficiently stored for later use, such as searching and reporting.

Preferably, the Report Formatter 218 is implemented as an XSLT document, a computer program written in a language such as C++, C#, Java, or the like, object oriented design and program, store procedures of a relational database, or the like.

In the preferred embodiment, the Expanded Report 220 comprises as an XHTML document in a chosen language. One of ordinary skill in the art will appreciate that the “Value” property may be written in any language such as English, Spanish, Russian, or the like, which results in an Expanded Report in that chosen language. Additionally, the ordering of nodes as specified by the Object Placement property (Table 4, Row 8), container sets, and Report Formatter rules may be altered to accommodate grammatical differences in the language of choice. The Report Formatter rules refer to the sequencing and grammatical rules that define the sequencing of the word values associated with the nodes, grammar (conjunction plurality, punctuation, and the like), sentence structure (capitalization, commas, periods, and the like), paragraph structures, and the like.

Preferably, the Expanded Report 220 comprises an HTML document, so that it can be rendered via a web browser. However, other embodiments, such as plain text, rich text format (RTF), portable data format (PDF), any other marked-up format that contains text with formatting tags, or the like, do not depart from the scope of the present invention.

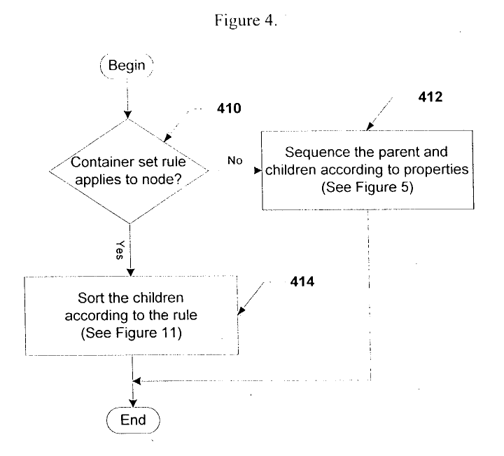

The processing preferably performed by the Report Formatter 218 is discussed in greater detail below with reference to FIGS. 4-6.

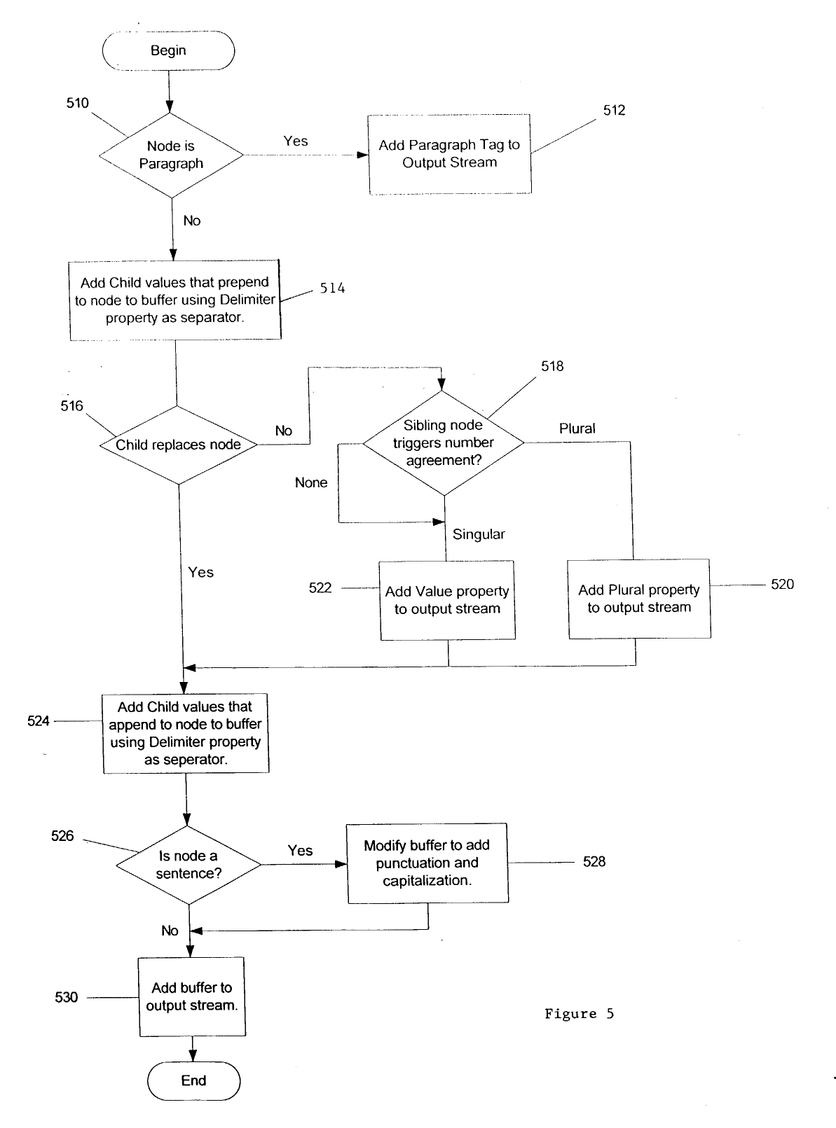

FIG. 4 is a flow chart that represents the steps performed by the Report Formatter to combine the nodes of a decision tree into an Expanded Report 220 (FIG. 2), in accordance with an embodiment of the present invention. Processing begins in step 410, wherein a determination is made whether or not a container set rule applies to the node. Preferably, this determination is made by pattern matching, i.e., determining whether the node that is currently being evaluated matches a node to which one or more container sets apply. If, in step 410, a determination is made that the container set rule does not apply, then processing proceeds to step 412, wherein the parent node and the children nodes, if any, are sequenced in accordance with the property values associated with the respective nodes. The process associated with step 412 is discussed in greater detail below with reference to FIG. 5.

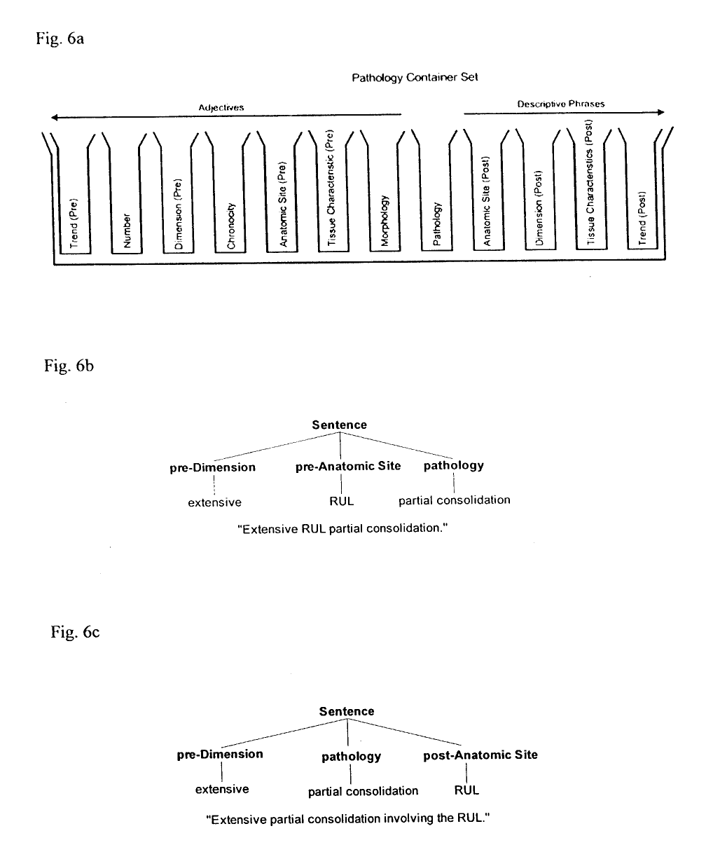

If, in step 410, a determination is made that a container set rule does apply, then processing proceeds to step 414, wherein the children nodes are sorted in accordance with the container set. The process associated with step 414 is discussed in greater detail below with reference to FIG. 6.

FIG. 5 is a data flow diagram that represents the steps performed by the Report Formatter 218 to sequence the parent and children nodes according to each node's properties as specified in step 412 (FIG. 4), in accordance with an embodiment of the present invention. Specifically, if a determination is made in step 410 (FIG. 4) that the sequence of the parent and child nodes is performed in accordance with the property values of the node, then processing proceeds to steps 510-530 (FIG. 5), after which processing returns to FIG. 4. Preferably, the nodes are processed in accordance with an in-order (i.e., left-parent-right) binary tree traversal method.

Preferably, when the node's properties are used to establish the ordering of node values, the ordering is determined by the value of the “Children's Object Placement” property contained in Table 4. As described in Table 4, the “Children's Object Placement” property includes a descriptor that specifies how the node's “Value” property value is to be treated. Preferably, the “Children's Object Placement” property includes alternatives such as prepend to parent, replace parent, append to parent, or the like. Optionally, a default value, such as append to parent, may be assigned.

Additionally, the output generated from the node may be further formatted dependent upon the values assigned to other fields, such as the “Is Paragraph” and “Is Sentence” properties of Table 4 and the “Delimiter” property of Table 2. Preferably, if the “Is Paragraph” property is set to true, a new paragraph is generated in the Expanded Report 220 prior to outputting the value of the node. If the “Is Paragraph” property is set to false, a value of the node is a phrase that modifies the parent node. If the “Is Sentence” property is set to true, a new sentence is generated in the Expanded Report prior to outputting the value of the node. Other formatting commands may also be used, some of which are specified in Table 4, Output Behavior Properties.

Accordingly, the processing begins in step 510, wherein a determination is made whether or not the node begins a paragraph. Preferably, the “Is Paragraph” property of Table 4 is a Boolean data type that has a value of either true or false. A value of true indicates that a new paragraph is to be generated in the Expanded Report prior to outputting the value of the node. Accordingly, if in step 510 it is determined that the “Is Paragraph” property contains a value of true, then processing proceeds to step 512, wherein the Report Formatter adds a paragraph tag, such as “<P>”, to the output stream prior to outputting the value of the node. Preferably, the default value for the “Is Paragraph” property is false.

After step 512 or step 510, if in step 510 it is determined that the “Is Paragraph” property contains a value of false, processing proceeds to step 514, wherein the Report Formatter adds the value of child nodes whose value of the “Object Placement” property indicates that the value of the child node is to be prepended to the value of the parent node, using the value of the “Delimiter” property as a separator. As described in the sixth row of Table 2, the “Delimiter” property value specifies the way in which the values of the child nodes are to be combined. The value of the “Delimiter” property preferably is an enumeration data type that has a value of either “Comma,” “And” or “Space.” This delimiter is inserted between the values of the children. “Comma” indicates that the values of the child nodes are separated by a comma; “And” indicates that the conjunction “and” is inserted before the last of a series of child values; and “Space” indicates that the values of the child nodes are separated by a space character. Preferably, the default value for the “Delimiter” property is “Space.”

Thereafter, processing proceeds to step 516, wherein a determination is made whether or not the value of the child node should replace the value of the parent node. If a determination is made that the value of the child node should not replace the value of the parent node, processing proceeds to step 518, wherein a determination is made whether or not the sibling nodes (nodes at the same level) of the node triggers a number agreement. Preferably, the node properties contains a “Triggers Number Agreement” property of an enumeration data type having values of “None,” “Singular” or “Plural.” If the value of the “Triggers Number Agreement” property of sibling nodes is “None” or “Singular,” the singular form of the node is utilized. If, however, the value of the “Triggers Number Agreement” property is “Plural,” then the plural form, such as “mass”/“masses”, “tibia”/“tibiae”, “fracture”/“fractures”, and the like, are utilized. Preferably, the plural form of a node is stored in the “Plural Object Value” property, and the “Value” property stores the value of the singular form. Preferably, the default value of the “Triggers Number Agreement” property is “None.”

Accordingly, if in step 518 it is determined that the sibling nodes of the node triggers a plural value, then processing proceeds to step 520, wherein the value contained in the “Plural Value” property of the node is outputted. If it is determined, in step 518, that the sibling nodes of the node do not trigger a plural value, then processing proceeds to step 522, wherein the value contained in the “Value” property of the node is outputted, i.e., the singular value of the node is outputted.

After step 520, step 522, or step 516 (if a determination is made in step 516 that the child node replaces the parent node) processing proceeds to step 524, wherein the Report Formatter 218 ignores the value of the parent node and adds child values that append to the parent node to the buffer, using the value of the “Delimiter” property as a separator.

Processing then proceeds to step 526, wherein a determination is made whether or not the node completes a sentence. As shown in the fourth row of Table 4, the value of the “Is Sentence” property is a Boolean data type that has a value of either true or false. When the “Is Sentence” property value is true, the Report Formatter 218 treats the value of this node as a full sentence in the report. Accordingly, if a determination is made that the node is a sentence, then processing proceeds to step 528, wherein the Report Formatter 218 modifies the buffer to add punctuation and capitalization. If, however, in step 528, a determination is made that the node is not a sentence, i.e., the value of the “Is Sentence” property is false, the Report Formatter 218 treats the value as a phrase that modifies a parent node. The default for the value of the “Is Sentence” property is false. When all of the values of the parent and children have been accumulated in the buffer, the buffer contents are added to the output stream as shown in step 530.

Both step 514 and step 524 represent the Report Formatter 218 adding the values of the child nodes to the buffer. Preferably, when child nodes are added to the buffer, the value of the “Children's Order Fixed” property determines the order in which the children are listed. The “Children's Order Fixed” property is a Boolean data type that has a value of either true or false. When the value is true, the nodes are formatted in the order in which they appear in the decision tree. Otherwise, when the value is false, the nodes are aggregated in the order in which the user selected them. The default value is true. Thereafter, processing returns to FIG. 4.

FIG. 6a shows an example of a container set rule. Rule 1101 for Primary Modifiers (labeled “Adjectives” in FIG. 6) shows the sequence of nodes that are output for a description of a pathology. ‘Trend (Pre)’ is the first category, ‘Number’ is the second, and ‘Morphology’ is the last category. Nodes may be presented in a decision tree in any order (for example, Pathology, Morphology, Pre-Anatomic Site, Pre-Dimension, Number, Chronicity, Pre-Trend, Interactions, Associations), but are preferably outputted in a report in the order specified by the Container Set rule. For illustrative purposes only, FIG. 6b illustrates an example of output that may be obtained utilizing the container set 1101. The value of the pre-dimension node (i.e., extensive) is positioned prior to the value associated with the pre-anatomic site node (i.e., RUL). The value associated with the pathology node (i.e., partial consolidation) is positioned last. Thus, the sentence becomes, “Extensive RUL partial consolidation.”

Similarly, Rule 1102 for Secondary Modifiers (labeled “Adjectives” in FIG. 6) shows the sequence of nodes that are also output for a description of a pathology. For illustrative purposes only, FIG. 6c illustrates an example of output that may be obtained utilizing the container set 1102. The value of the pre-dimension node (i.e., extensive) is positioned prior to the value associated with the pathology node (i.e., partial consolidation). The value associated with the post-anatomic site node (i.e., RUL) is positioned last. Thus, the sentence becomes, “Extensive partial consolidation involving the RUL.”

Preferably, the embodiment of a container set depends on the embodiment chosen for the Report Formatter. In one embodiment, where the Report Formatter is specified using the Extensible Stylesheet Language (XSL), a container set may be represented as an XSL template. Other embodiments may include, but are not limited to, conditional if-then-else statements in a procedural programming language, rule objects with conditions and actions in an object-oriented language, declarative rules in an expert system or a business rules engine, or the like.

FIG. 7 is a flow chart that represents the steps performed by the Findings Editor 214 (shown in FIG. 4) to convert a decision tree into a Structured Report 216, in accordance with an embodiment of the present invention. Preferably, the steps involve performing a pre-order tree traversal, wherein the properties of selected parent nodes are added to the Structured Report 216, and then the properties of each of the selected child nodes of the parent node are added to the Structured Report 216. Preferably, the hierarchical structure of a decision tree is represented as an XML document, where the tree root node is represented as the root XML element. Each node in the tree is transformed as an element that contains elements which represent the node's properties.

Accordingly, processing begins in step 710, wherein the Findings Editor 214 outputs opening tags for a parent node. Tags define how a Web page is to be displayed and enable user interactions. For example, the opening node tag appears as “<NODE>” wherein the tag or instruction is surrounded by a less-than and a greater-than sign. Tags generally appear in pairs—the opening tag and the closing tag. The closing tags are similar to the opening tags except for a forward slash in the closing tag. For example, a node will be surrounded by the NODE tags: “<NODE>child elements</NODE>.” The closing “</NODE>” tag is discussed below in reference to step 722.

Processing proceeds to step 712, wherein the Findings Editor 214 outputs the desired properties contained in the Tables 1-5 as tags and values. Preferably, all of the properties contained in Tables 1-5 are added to the Structured Report 216. However, one of ordinary skill in the art will realize that some embodiments of the present invention may not require retention of all of the properties contained in Tables 1-5, such as, for example, Table 3, Input Behavior Properties. In step 714, the Findings Editor 214 outputs opening list tags for the list of child nodes.

In step 716, a determination is made whether or not the parent node contains more child nodes. If a determination is made that the parent node contains more child nodes, processing proceeds to step 718, wherein the child node is processed. Preferably, the child node is processed by a recursive call to the node processing routine of the Findings Editor 214. Specifically, the child node is preferably processed by beginning processing at step 710 for the specific child node, which may be a parent node to other nodes.

If, however, in step 716, a determination is made that there are no more child nodes to process, processing proceeds to step 720, wherein the closing list tags associated with the parent node are outputted.

When all of a child nodes have been processed, the parent node outputs its own closing tags, as shown by block 722. It is noted that the original parent node is the node that begins the process at each level in the hierarchical tree. Thus, the process is recursive and each node is handled relative to its position in the hierarchy, and a node may be both a parent and a child, because these terms refer to relative relationships with other nodes, not absolute positions in the tree.

Performing the pre-order tree traversal discussed above results in a well-formed XML document, in which the hierarchical structure of the nodes is represented by the embedding of elements within each other and the content of the decision tree is represented as elements within each node.

XML provides a flexible format that allows for certain modifications of the hierarchical structure, without having to change the processors of the data. For example, it is possible to add a new property to a node without having to modify the parser that reads decision trees. Another advantage of XML is that it is widely used for transferring data between organizations. Therefore, integration with other systems is easier due to the use of XML for decision trees. Finally, there are many third-party tools available for processing XML, which makes it easier to develop applications to process decision trees.

For illustrative purposes only, FIG. 8 illustrates a Report Template and a dynamically created Expanded Report that documents the structured analysis of a particular radiological study in accordance with an embodiment of the present invention. As discussed above, the Expanded Report is preferably created on the right-hand side as the user selects and de-selects items in the Report Template on the left-hand side. The template 800 contains an initial layer 802 of choices that comprises the following: Organ morphology (Om) 804, Organ physiology (Op), Specific pathology (Sp), General pathology (Gp) 806, and Negatives (N) 808.

The Organ morphology choice 804 defines pathological entities that describe pathological architectural alterations of organs or organ systems, as well as pathological changes in the tissue characteristics of organs or organ systems.

The Organ physiology choice defines pathological entities that describe physiological alterations of organs or organ systems.

The Specific pathology choice defines a list of specific diseases of specific organs or specific organ systems or well-known syndromes. Upon demand by the user, the reporting system may provide specific information regarding a specific disease entity with respect to a disease synopsis or specific radiological features.

The General pathology choice 806 defines and provides analysis of unknown disease processes of organs or organ systems and the reporting system may provide differential diagnoses of general disease entities upon demand by the user.

The Negatives choice 808 defines an exhaustive list of pertinent negatives.

The comments choice (not shown) allows the user to enter comments by using an input device (e.g., voice input, mouse, keyboard, etc.) that is connected to the interface devices 110.

Each major division is composed of a set of choices consisting of minor divisions. The minor divisions are contained within the second layer 810, and the minor divisions, include the following: *Number(Nb) 812, Pathology(P) 814, *Morphology(M) 816, *Chronicity(C) 818, *Dimensions(D) 820, Anatomic site(AS) 822, Tissue characteristics(Tc) (not shown), Interactions(I) 824, Associations(A) 826, *Trend(T) 828 and RADITFS (not shown).

The starred choices are the primary modifiers and are the same for all templates in all parts of the human body for all modalities. The unstarred choices are the secondary modifiers and are specific to a particular anatomic site within the human body and are particular to a specific modality.

The Number choice 812 is the first function in the output of the Report Formatter 218, and all other primary modifier functions follow this function. The Number choice 812 consists of a drill-down list comprised of the following: Possible, Single, One, Two, Three, Multiple, Numerous or other quantitative descriptors. The Number node 812 is a category, a way of organizing specific choices. Those choices (‘possible’, ‘single’, ‘two’, etc.) represent possible findings. For example, if the pathology is a ‘mass’, then a radiologist may specify the number of masses as “possible mass”, “single mass”, “two masses”, etc. Modifiers of a ‘multiple’ selection may be selected and attached consisting of identification of largest of two, 2nd largest of multiple, 3rd largest of three, etc. These selections are more specific descriptions of the term ‘multiple’. For example, a radiologist might simply specify “multiple masses” or something more specific, such as “2nd largest of multiple masses”.

The Pathology choice is a pathological process involving organ morphology 804 or organ physiology or specific pathology or general pathology and is the primary navigational tool. When a user selects a disease process under Pathology 814 in any of the above categories, the present invention provides the user with options that enable the creation of the output and provides access to other information. Further, when the Pathology choice 814 is highlighted under specific pathology, the user may select a Synopsis choice (not shown). The Synopsis choice displays a medical summary of the disease entity, including the Etiology, Incidence, Pathophysiology, Clinical features, Imaging characteristics and References of a specific disease entity.

The order in which different Pathology entities appear in the Impression section 832 is determined by the user's assignment of a relative sequence number (not shown) to a Pathology entity. Once the order has been specified by the user, a summary statement of the Pathology entity and associated modifiers will appear in the Impression section 832 in the relative order specified by the user

The output in the Findings section 830 consists of a certain combination of primary modifiers and a Pathology entity 814. For example, in FIG. 8, the Findings section 830 states: ‘Pathology: New 5 cm RUL cavitating mass.’

The output in the Impression section 832 consists of a variable subset of the primary modifiers. The subset may consist of Number 812, Pathology 814, Anatomic site, Morphology 816, Chronicity 818, Dimensions 820 and Trend 828 in a proscribed output order. The subset must include a Pathology entity 814.

The Differential Diagnosis section (not shown) contains a drill-down differential diagnosis list that may be selected for any Pathology entity. Up to three selections may be made from the list, and the output is ordered according to the user's selection order. The output of the selections is reformatted in a specific proscribed manner and is attached to the Impression section 832. When a Differential Diagnosis entity is highlighted the user may select Synopsis (not shown) and display a medical summary of the Differential Diagnosis entity.

A standard Recommendation list (not shown) may be selected for any Pathology entity. The output of the Recommendation is reformatted in a specific proscribed manner and is attached to the specific Impression 832 following the Differential Diagnosis. When the Differential Diagnosis option is not selected, then the Recommendation is attached directly to the Impression 832.

The Morphology function 816 is a primary modifier and immediately precedes the Pathology entity in the Findings 830 and Impression 832 output analytical algorithm. The Morphology function 816 defines the type of lesion, the shape of the lesion, the margins of the lesion and the internal structure or matrix of the lesion.

The Anatomic (pre) site is a primary modifier and immediately precedes the Morphology function 816 in the Findings 830 and Impression 832 output analytical algorithm.

The Chronicity function 818 is a primary modifier and immediately precedes the pre-Anatomic site function in the Findings 830 and Impression 832 output analytical algorithm. The Chronicity function 818 defines the age of the lesion and defines age as hyper-acute, acute, sub-acute, chronic, old and indeterminate aged Pathology 814.

The Dimension function 820 is a primary modifier and immediately precedes the Chronicity function 118 in the Findings 830 and Impression 832 output analytical algorithm. The Dimension function 820 defines the size of the lesion qualitatively or quantitatively.

The detailed post-Anatomic site 822 function is a secondary modifier and follows the Pathology 814 entity and its primary modifiers and is contained in the same sentence.

The Tissue characteristics (not shown), Interactions 824 and Associations 826 functions are special functions with special attachment tools, which may secondarily modify a Pathology 814 entity in a subsequent section. The Tissue characteristics function displays general tissue characteristics utilized in the description of a general or specific Pathology 814 entity.

When a Pathology entity under Specific pathology (not shown) is highlighted the user may select Tissue characteristics and display the classic Tissue characteristics of that specific disease entity.

The Interaction function 824 describes the direct effects of the Pathology 814 entity upon immediately surrounding anatomical structures. The Interaction function 824 consist of a drill-down list of Interaction descriptors coupled to a recursive anatomic site list which displays in a proscribed manner in the output analytical algorithm in the Findings sections 830. The Interaction function 824 secondarily modifies the Pathology entity 814 in a subsequent section.

The Associations function 826 displays general radiological features of a General pathology pathological entity and specific detailed radiological features of a Specific pathology pathological entity. The specific pathology entity is coupled with the specific Associations for that specific pathology entity and selected features may be selected by the user and displayed in a proscribed manner in the output analytical algorithm in the Findings section 830.

The Trend function 828 is a secondary modifier which describes the course of disease over time and stands alone. The Trend function may be selected for each and every Pathology entity.

RADITFS function (not shown) is selected in the Impression and displayed in the Impression 832 only. RADITFS or ‘RADIOLOGIC ANALYSIS DETAILED IN THE findings SECTION’ is attached to the Impression 832 following differential diagnosis and Recommendations.

This concludes the description of the preferred embodiment of the invention. The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed:

1. A method of generating an expanded report on a computer, the method comprising the steps of:
displaying a report template having one or more nodes to a user, each node having one or more properties that define behavior and appearance of each node in the report template;
receiving from the user one or more selected nodes of the report template; and
generating the expanded report from the selected nodes by converting each of the selected nodes into one or more phrases.

2. The method of claim 1 including the steps of:
creating from the selected nodes a structured report identifying which nodes the user selected; and
storing the structured report to allow the user to search the contents of the structured report.

3. The method of claim 1, wherein the step of generating includes the steps of:
generating the expanded report dynamically as the user selects the selected nodes; and
displaying the phrases dynamically as the user selects the selected nodes.

4. The method of claim 1, wherein the step of generating includes the steps of:
generating the expanded report dynamically as the user selects selected nodes; and
displaying the phrases dynamically as the user selects the selected nodes;
wherein the phrases are displayed as natural language phrases.

5. The method of claim 1, wherein the expanded report is electronically distributed.

6. The method of claim 1, wherein the expanded report is grammatically correct and contains natural language phrases.

7. The method of claim 1, wherein the report template is displayed as a hierarchical tree, and wherein the step of generating the expanded report includes the step of ordering the nodes in accordance with at least one of a position of selected nodes in the hierarchical tree, an order in which nodes are selected by the user, or a pre-defined order from a container set.

8. The method of claim 1, wherein the step of generating the report includes the step of generating punctuation and capitalization based at least in part on the properties of the node or a container set rule, the container set rule specifying a sequence one or more of the nodes are to be outputted in the expanded report.

9. The method of claim 4, wherein the step of generating includes the step of outputting a pre-defined conjunction in accordance with at least one of a container set rule and the properties of each node, the container set rule specifying the sequence the information related to one or more of the nodes are to be outputted in the report.

10. The method of claim 1, wherein the step of generating includes the step of outputting a phrase related to the nodes in singular or plural form based at least in part on the properties of other nodes in the phrase.

11. The method of claim 1, wherein the step of generating the report includes the steps of:
determining whether the selected nodes are to be ordered in accordance with a container set rule or the one or more node properties defining the behavior and appearance of each node;
upon determining that the selected nodes are to be ordered in accordance with the container set rule, creating an expanded report containing data represented by the selected nodes in an order specified by the container set rule; and
upon determining that the selected nodes are to be ordered in accordance with the node properties, performing for each selected node the substeps of:
outputting information represented by one or more child nodes having a node property that indicates the child node prepends the selected node;
outputting information represented by the selected node; and
outputting information represented by the one or more child nodes having a node property that indicates the child node appends the selected node.

12. The method of claim 1, wherein a container set rule causes one or more nodes to appear in more than one location in the expanded report.

13. The method of claim 1, wherein the nodes are organized in a hierarchical manner, and wherein the step of displaying includes displaying the nodes in the hierarchical manner.

14. The method of claim 1, wherein the step of displaying includes displaying one or more selected nodes and displaying one or more non-selected nodes.

15. The method of claim 1, wherein the nodes of a decision tree can be replicated dynamically when the user is selecting nodes, so that a particular subtree can be reused.

16. A method of generating an expanded report on a computer, the method comprising the steps of:
receiving from a user a selection of a starting template from one or more report templates and one or more previous structured reports, the report templates having one or more nodes representing alternative findings and the previous structured report having one or more nodes previously selected by the user;
receiving from the user one or more selected nodes of the starting template;
generating a structured report from the selected nodes, the structured report identifying the nodes selected by the user; and
generating the expanded report from the selected nodes.

17. The method of claim 16, wherein the expanded report is generated dynamically as the user selects the one or more selected nodes.

18. The method of claim 16, wherein the expanded report is electronically distributed.

19. The method of claim 16, wherein the expanded report is grammatically correct and contains natural language phrases.

20. The method of claim 16, wherein the report template is displayed as a hierarchical tree, and wherein the step of generating the expanded report includes the step of ordering the nodes in accordance with at least one of a position of selected nodes in the hierarchical tree, an order in which nodes are selected by the user, or a pre-defined order from a container set.

21. The method of claim 16, wherein the step of generating the report includes the step of generating punctuation and capitalization based at least in part on the properties of the node or a container set rule, the container set rule specifying a sequence one or more of the nodes are to be outputted in the expanded report.

22. The method of claim 16, wherein the step of generating includes the step of outputting a pre-defined conjunction in accordance with at least one of a container set rule and the properties of each node, the container set rule specifying the sequence the information related to one or more of the nodes are to be outputted in the report.

23. The method of claim 16, wherein the step of generating includes the step of outputting a phrase related to the nodes in singular or plural form based at least in part on the properties of other nodes in the phrase.

24. The method of claim 16, wherein the step of generating the report includes the steps of:
determining whether the selected nodes are to be ordered in accordance with a container set rule or the one or more node properties defining the behavior and appearance of each node;
upon determining that the selected nodes are to be ordered in accordance with the container set rule, creating an expanded report containing data represented by the selected nodes in an order specified by the container set rule; and
upon determining that the selected nodes are to be ordered in accordance with the node properties, performing for each selected node the substeps of:
outputting information represented by one or more child nodes having a node property that indicates the child node prepends the selected node;
outputting information represented by the selected node; and
outputting information represented by the one or more child nodes having a node property that indicates the child node appends the selected node.

25. The method of claim 16, wherein the nodes of a decision tree can be replicated dynamically when the user is selecting nodes, so that a particular subtree can be reused.

26. A computer program product for providing generating an expanded report on a computer, the computer program product having a medium with a computer program embodied thereon, the computer program comprising:
computer program code for displaying a report template having one or more nodes to a user, each node having one or more properties that define behavior and appearance of each node in the report template;
computer program code for receiving from the user one or more selected nodes of the report template; and
computer program code for generating the expanded report from the selected nodes by converting each of the selected nodes into one or more phrases.

27. The computer program product of claim 26 including:
computer program code for creating from the selected nodes a structured report identifying which nodes the user selected; and
computer program code for storing the structured report to allow the user to search the contents of the structured report.

28. The computer program product of claim 26, wherein the computer program code for generating includes:
computer program code for generating the expanded report dynamically as the user selects the selected nodes; and
computer program code for displaying the phrases dynamically as the user selects the selected nodes.

29. The computer program product of claim 26, wherein the computer program code for generating includes:
computer program code for generating the expanded report dynamically as the user selects selected nodes; and
computer program code for displaying the phrases dynamically as the user selects the selected nodes, the phrases being displayed as natural language phrases.

30. The computer program product of claim 26, further comprising:
computer program code for electronically distributing the expanded report.

31. The computer program product of claim 26, wherein the computer program code for generating includes computer program code for generating a grammatically correct and natural language expanded report.

32. The computer program product of claim 26, wherein the computer program code for displaying includes computer program code for displaying the report template as a hierarchical tree, and wherein the computer program code for generating the expanded report includes the computer program code for ordering the nodes in accordance with at least one of a position of selected nodes in the hierarchical tree, an order in which nodes are selected by the user, or a pre-defined order from a container set.

33. The computer program product of claim 26, wherein the computer program code for generating the report includes computer program code for generating punctuation and capitalization based at least in part on the properties of the node or a container set rule, the container set rule specifying a sequence one or more of the nodes are to be outputted in the expanded report.

34. The computer program product of claim 26, wherein the computer program code for generating includes computer program code for outputting a pre-defined conjunction in accordance with at least one of a container set rule and the properties of each node, the container set rule specifying the sequence the information related to one or more of the nodes are to be outputted in the report.

35. The computer program product of claim 26, wherein the computer program code for generating includes the computer program code for outputting a phrase related to the nodes in singular or plural form based at least in part on the properties of other nodes in the phrase.

36. The computer program product of claim 26, wherein the computer program code for generating the report includes:
computer program code for determining whether the selected nodes are to be ordered in accordance with a container set rule or the one or more node properties defining the behavior and appearance of each node;
upon determining that the selected nodes are to be ordered in accordance with the container set rule, computer program code for creating an expanded report containing data represented by the selected nodes in an order specified by the container set rule; and
upon determining that the selected nodes are to be ordered in accordance with the node properties, computer program code for:
computer program code for outputting information represented by one or more child nodes having a node property that indicates the child node prepends the selected node;
computer program code for outputting information represented by the selected node; and
computer program code for outputting information represented by one or more child nodes having a node property that indicates the child node appends the selected node.

37. The computer program product of claim 26, including computer program code for causing one or more nodes to appear in more than one location in the expanded report in accordance with one or more container set rules.

38. The computer program product of claim 26, wherein the computer program code for displaying includes computer program code for displaying the nodes in a hierarchical manner.

39. The computer program product of claim 26, wherein the computer program code for displaying includes computer program code for displaying one or more selected nodes and displaying one or more non-selected nodes.

40. The computer program product of claim 26, further comprising computer program code for replicating one or more nodes of a decision tree dynamically so that a particular subtree can be reused.

41. A method of creating a structured report, comprising:
at a server computer,
(a) converting a decision tree into an XML document by performing a pre-order tree traversal, wherein the XML document contains one or more nodes;
(b) storing the XML document in a storage device connected to the server computer;
at the client computer,
(c) receiving the XML document from the server computer;
(d) displaying the XML document to a user;
(e) receiving information about the nodes from the user, wherein the information includes at least one selected node;
(f) dynamically creating the structured report by converting the selected node into a meaningful sentence that consists of one or more sentence fragments at the server computer,
(g) receiving the structured report from the client computer;
(h) storing the structured report in the database that is connected to the server computer; and
(i) distributing the structured report electronically.
